(19) United States
(12) Patent Application Publication
(10) Pub. No.: US 2023/0073696 A1
(43) Pub. Date: Mar. 9, 2023

(54) SYSTEM, METHOD, AND SOFTWARE FOR 2D OR 3D MODEL EXTRACTION FROM MANUAL DRAWING

(71) Applicant: mohammad shafikul huq, HAMTRAMCK, MI (US)

(72) Inventor: mohammad shafikul huq, HAMTRAMCK, MI (US)

(73) Assignees: mohammad shafikul huq, HAMTRAMCK, MI (US); shakura quabili, HAMTRAMCK, MI (US)

(21) Appl. No.: 17/880,656

(22) Filed: Aug. 4, 2022

Related U.S. Application Data
(60) Provisional application No. 63/241,039, filed on Sep. 6, 2021.

(51) Int. Cl. G06T 17/10; G06T 15/10; G06T 11/20; G06T 17/30

(52) U.S. Cl. CPC G06T 17/10; G06T 15/10; G06T 11/203; G06T 17/30; G06T 2210/32; G06T 2210/21

(57) ABSTRACT

The system, method, and software in the presented invention converts manually drawn 2D projection pictures into their corresponding mathematically defined 2D or 3D model. The manually drawn model is drawn in a computer with a device such as mouse. A software executed in the computer then automatically finds junction points and curves between junction points and fits smoothed and mathematically defined curves between the junction points. Alternatively, junction points and the representative polynomials of the curves are mentioned manually by users. The 2D or 3D mathematical models are then reprojected by the said software to obtain the desired, more accurate, and smooth projections. The reprojection can be done from different viewing angles if needed, which avoids the hassle of redrawing the models.

### FIELD OF THE INVENTION

The present invention relates to conversion of manually drawn 2D projections of 2D or 3D models into their corresponding 2D or 3D models that are mathematically defined. The conversion is done using software running in a computer.

### CROSS REFERENCE TO RELATED APPLICATION

This application is a continuation application of U.S. Provisional Patent Application No. 63/241,060, filed Sep. 6, 2021 with conformation number 6605, the contents of which are incorporated herein by reference almost in their entirety, with claims unchanged.

### BACKGROUND

Word processing or presentation software such Microsoft Word or Power Point facilitate for users to manually draw 2D or 3D models using free hand or flexible lines and curves. These 2D or 3D models are often not available in or offered by software as pre-drawn models, mostly because the software packages do not know about the models the user needs to draw. Therefore, users end up drawing their models manually using devices such as mouse. When manually drawn, the pictures are often in 2D or 2D projections of 3D models comprising points, lines, and curves connected together. These manually drawn models are imperfect or unusual in shape.

Therefore, there is a need for software that could convert this manually drawn shapes into mathematically defined models and then reproject them. The reprojected pictures will look smooth and well defined. After model is available, a reprojection can be done from different viewing angle if needed to avoid the hassle of redrawing the models.

In U.S. Ser. No. 11/094,137B2, a machine learning approach is claimed to extract 3D model from 2D projections. A relevant patent in the line of our proposed invention is US20170345222A1 where outlines of image of an object are detected automatically from the image, then the outlines are fit into geometric primitives, and finally a 3D model is extracted. In proposed invention of our application, the model extraction starts with a hand drawn projection made with a device, such as, a computer. A user then describes the projection with geometric primitives and intersections, if any, of the primitives interactively by selecting drawing elements of the projections explicitly, as opposed to fitting the primitives into outlines as described in the patent. The application of our invention is different as well, which is enabling a user to generate more accurate or relevant projection of underlying 2D or 3D model of a drawing, where the drawing is a 2D projection. After a model is extracted, the user is able to rotate the model and use a projection of his/her choice.

### BRIEF SUMMARY OF THE INVENTION

The system, method, and software in the presented invention converts hand-drawn 2D projection into their corresponding mathematically defined 2D or 3D models. The hand drawn model is drawn in a computer. A software executed in the computer then automatically finds junction points and fits curves between the junction points to obtain mathematically defined 2D or 3D models. Alternatively, junction points and the representative polynomials of the curves are mentioned manually by users. The 2D or 3D mathematical models are then reprojected by the said software to obtain more accurate, well defined, smooth projections which are most likely to be up to the user's expectation. The reprojection can be done from different viewing angles if needed, which avoids the hassle of redrawing the models.

### BRIEF DESCRIPTION OF THE DRAWINGS

System and method of the present invention are illustrated as an example and are not limited by the figures of the accompanying diagrams and flowcharts, in which:

FIG. 1 shown an exemplary input to the proposed software and the corresponding output delivered by the software.

FIG. 2 depicts a flowchart comprising various steps in sequences to show how 2D drawing or scan is converted into mathematically defined 2D or 3D models.

### DETAILED DESCRIPTION OF THE INVENTION

The terminology used herein for the purpose of describing the system and method is not intended to be limiting the invention. The term ‘and/or” includes any and all combinations of one or more of the associated listed items. As used herein, the singular forms “a,” “an”, and “the” are intended to include the plural forms as well as singular forms, unless the context clearly indicates otherwise. The term “comprising” and/or “comprises” specify the presence, when used in this specification, specify the presence of stated features, steps operations, elements, and/r components, but do not preclude the presence or addition of one or more other features, steps, operations, elements, components, and/or groups/thereof.

If not otherwise defined, all terms used herein have the same meaning as commonly understood by one having ordinary skill in the art to which this invention belongs. Furthermore, terms, such as those defined in commonly used dictionaries, should be interpreted as having a meaning that is consistent with their meaning in the context of the relevant art and the present invention and will not be interpreted in an idealized or overly formal sense unless expressly so defined herein.

In the description of the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. However, the specification and claims should be read with the understanding that such combinations are entirely within the scope of the invention and the claims.

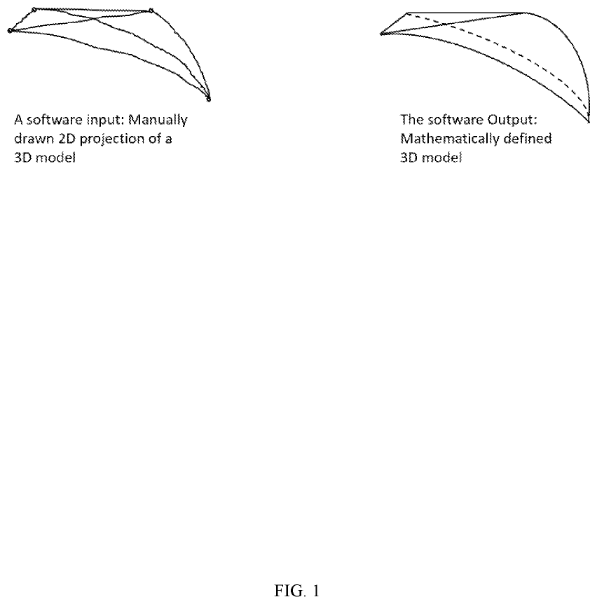

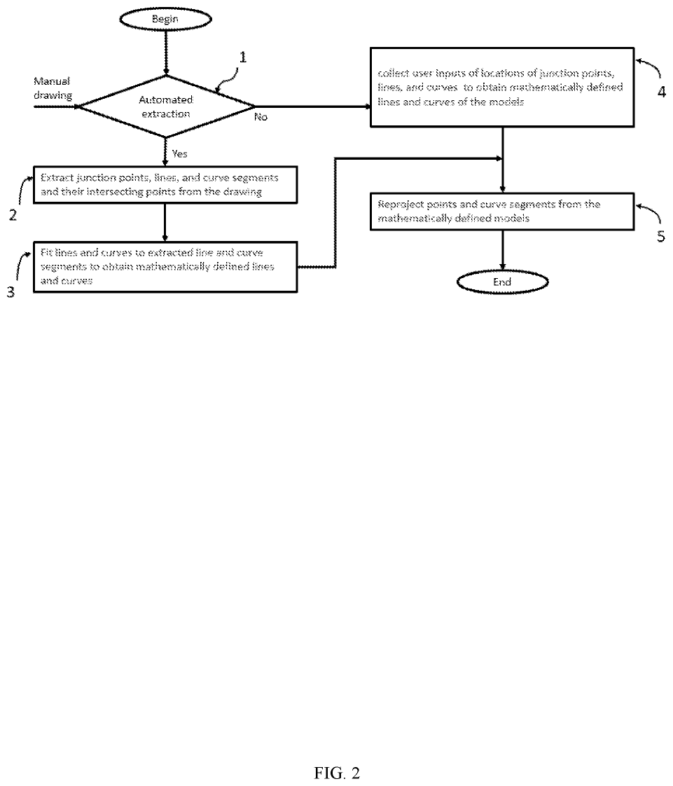

The present invention, a system and method for stopped vehicle driver alert, will now be described by referencing the appended figures, FIG. 1 and FIG. 2, representing the preferred embodiments.

The system, method, and software in the presented invention converts hand-drawn 2D projection into mathematically defined 2D or 3D model. The hand drawn model is drawn in a computer using device such as mouse. A software executed in the computer then automatically finds junction points and curves between them 2, and fits polynomials on the curves and junction points 3. Alternatively, junction points and the representative polynomials of the curves are mentioned manually by users 1, 4. The 2D or 3D mathematical models are then reprojected 5 by the said software to obtain the desired and more accurate, smooth projections.

1. A system where hand-drawn 2D projection of a 2D or 3D model is converted into mathematically defined 2D or 3D model, the said system comprising:
a computer to manually draw and display a 2D projection picture of a 2D or 3D model; and
a computer mouse and/or keyboard to mark or choose points and mention simple characteristics such as ‘line’, ‘curve’ for connecting curves passing through two or more points or detailed characteristics such as equations for the connecting curves passing through two or more points.

2. A method to convert a hand-drawn 2D projection of a 2D or 3D model into mathematically defined 2D or 3D model, the said method comprising steps:
analyzing the hand-drawn projection to find out intersection points and connecting curves between points;
determining or collecting the degree of polynomial of the connecting curves between the points;
estimating the parameters of the lines and curves;
regenerating the projected model points; and
saving the said degree and parameters of the said polynomials associated to the model.

3. A software as defined in claim 1, wherein the software is executed in the said computer in claim 1 and applies the said method in claim 2.

4. The software as defined in claim 3, wherein the software could reproject the said mathematically defined 2D or 3D model from a different viewing angle.
